(19) United States
(12) Patent Application Publication
(10) Pub. No.: US 2005/0150979 A1
(43) Pub. Date: Jul. 14, 2005

(54) Locomotive engine economy enhancement with improved nozzle

(75) Inventors: Manoj Gokhale, Bangalore (IN); Benzi John, Bangalore (IN); Vaidyanathan Krishnamurthy, Bangalore (IN); Roy James Primus, Niskayuna, NY (US)

Correspondence Address: GERALD W SPINKS, P. O. BOX 2467, BREMERTON, WA, 98310, US

(73) Assignee: General Electric Company, Schenectady, NY (US)

(21) Appl. No.: 10/847,644

(22) Filed: May 17, 2004

Related U.S. Application Data
(60) Provisional application No. 60/536,682, filed on Jan. 14, 2004.

(51) Int. Cl. F02M 61/00

(52) U.S. Cl. 239/533.12; 239/533.3

(57) ABSTRACT

A method and apparatus for improving fuel economy in a diesel engine, by improving fuel dispersion through the injection nozzles to promote more efficient combustion. The method can also involve retarding injection timing to decrease emissions and increasing the compression ratio, and improving turbocharger performance, to increase fuel economy.

### CROSS REFERENCE TO RELATED APPLICATIONS

This application relies upon U.S. Provisional Pat. App. No. 60/536,682, filed Jan. 14, 2004, for “Locomotive Engine Economy Enhancement with Improved Nozzle”.

### STATEMENT REGARDING FEDERALLY SPONSORED RESEARCH OR DEVELOPMENT

Not Applicable

### BACKGROUND OF THE INVENTION

1. Field of the Invention

This invention relates to diesel engines for locomotives and the like; and, more particularly, to diesel engines whose emissions must meet Tier 0 emissions standards promulgated by the Environmental Protection Agency (EPA).

2. Background Art

In a diesel engine, fuel is directly injected into a cylinder of compressed air at a high temperature. The fuel is broken up into droplets which evaporate and mix with the air forming a combustible mixture. Products of combustion of this mixture are exhaust emissions that include hydrocarbons (HC), nitrogen oxides (NOx), carbon monoxide (CO), and particulate matter (PM). To reduce the amount of pollution in the atmosphere, the EPA regulates the emission level of these various exhaust products that is acceptable. Over time, the acceptable levels of emissions have been significantly reduced.

Attainment of these standards involves consideration of a number of factors relating to engine operation. These include such things as injection pressure and injection timing, nozzle spray patterns, hydraulic flow, manifold air temperature, compression ratio, and air/fuel ratios. As will be appreciated by those skilled in the art, changes to effect reduction of one type of emission may well result in an increase in another emission component. For example, retarding fuel injection timing, which effectively reduces NOx, also affects engine performance.

It is desirable, therefore, to effect a strategy for in-cylinder combustion which satisfies the Tier 0 requirements for NOx, while at the same time maintaining an acceptable level of engine performance, including fuel consumption.

### BRIEF SUMMARY OF THE INVENTION

Briefly stated, the present invention is directed to a method and apparatus for improving the operation of a locomotive diesel engine so as to improve fuel economy. This improvement can be usefully implemented, for instance, along with a modification to reduce NOx produced by the combustion of an air/fuel mixture.

For purposes of illustration only, the type of engine used as an example herein could be a mechanical unit injection, turbocharged, two stroke (two cycle) medium-speed diesel engine. The present invention could also be useful in four stroke engines. The invention could also apply to engines having electronic control units. Engines are available in 8, 12, 16, and 20 cylinder configurations, but the invention could also apply to other configurations.

The present invention provides a method and apparatus for improving fuel economy, which can, if desired, be implemented along with other methods for improving engine performance. Specifically, the present invention includes the use of a greater number of orifices in each fuel injection nozzle, with each orifice having a decreased diameter, as compared to a nominal fuel injection nozzle for a given engine.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a longitudinal section view of a nominal fuel injection nozzle;

FIG. 2 is a section view taken along the lines 2-2 in FIG. 1;

FIG. 3 is a partial section view of a nozzle orifice in an improved fuel injection nozzle according to the present invention; and

FIG. 4 is a section view taken along the lines 4-4 in FIG. 3.

### DETAILED DESCRIPTION OF THE INVENTION

A diesel engine has a plurality of combustion chambers or cylinders. As is well known in the art, air at an elevated temperature flows through an intake manifold and is drawn into the combustion chamber and compressed by movement of a piston. Air temperature in the intake manifold is controlled by an intake air cooling system which can include, for example, an aftercooler and a fluid coolant. Functions such as injection timing could be controlled by an electronic control unit, or they could be controlled mechanically through the use of other apparatus which is known in the art. Air pressure in the intake manifold is increased by an exhaust driven turbocharger. Fuel is injected into the combustion chamber through the nozzle of an injector and the resulting air/fuel mixture is burned. The products of combustion are then exhausted from the combustion chamber. As noted previously, the exhaust emissions include hydrocarbons (HC), nitrogen oxides (NOx), carbon monoxide (CO), and particulate matter (PM). As also noted, the EPA establishes standards for these emissions which the engine must meet or surpass in order to be acceptable for use. The exhaust gases are ducted to the turbine of a turbocharger, which turns the compressor. The compressor takes in ambient air and compresses it to a higher pressure for ducting into the intake manifold, via the cooling system.

Lowered NOx emissions can be achieved by retarding the injection timing. An increased compression ratio may be achieved by raising the piston crown height, or by lowering the cylinder head height so as to be closer to the piston crown when the piston is in top dead center position. Combinations of increased piston crown height and reduced cylinder head height to increase the compression ratio are also possible.

Various changes or modifications to the engine or the manner in which air and fuel are supplied to the cylinder affect the resulting level of each type of exhaust emission, as well as engine fuel economy and overall engine performance. If the start of injection (SOI) is retarded, the corresponding NOx, PM, and fuel consumption values are changed. For example, for a nominal engine, retarding the SOI by 4 crankshaft degrees to 4° ATDC (after top dead center) can have the effect of decreasing NOx to a value which is below the pertinent limit. It also has the effect of increasing PM, but the increase may be to a level that is still below the desired limit. Unfortunately, brake specific fuel consumption can substantially increase, representing a decrease in the thermal efficiency of the engine.

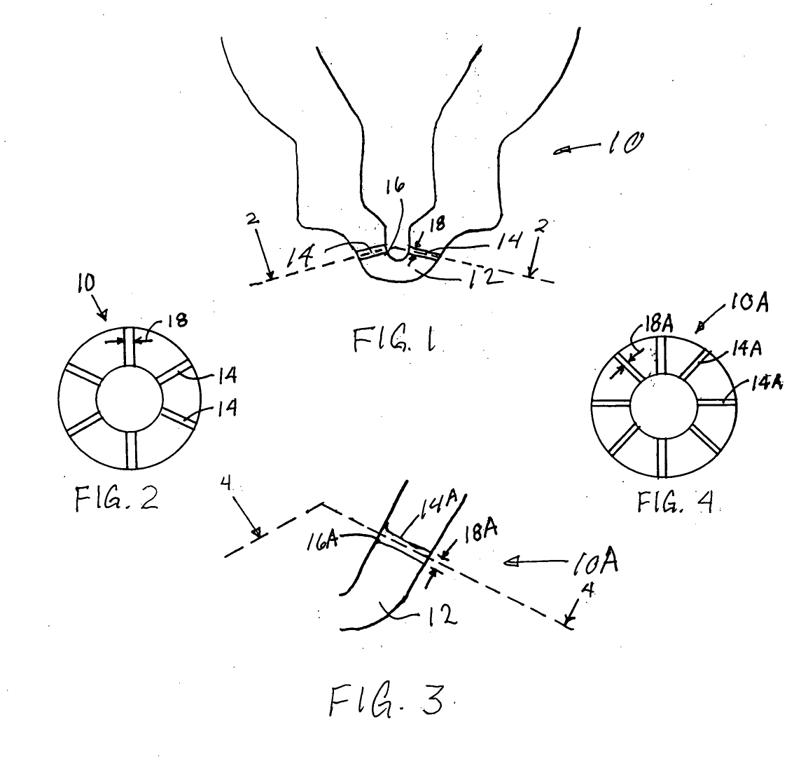

Other apparatus and techniques may also be employed, in accordance with the present inventive concepts, to improve fuel economy and thermal efficiency. A typical prior art or “nominal” fuel injection nozzle 10, as shown in FIGS. 1 and 2, has a projecting nozzle sac 12 near the end inside the combustion chamber, with a generally conically shaped wall which is penetrated by a plurality of nozzle orifices 14 (e.g., six (6) relatively large orifices as shown and described hereinafter). Fuel under pressure fills the nozzle sac 12 and exits through the orifices 14 into the combustion chamber. The applicants have found that the parameters (including the number, size, and shape) of these orifices 14 have a significant effect on the efficiency of fuel combustion in large, medium-speed diesel engines of the type used for powering railroad locomotives.

More particularly, the applicants have found that replacement of the typical prior art fuel injection nozzles 10 with improved fuel injection nozzles 10A, as shown in FIGS. 3 and 4, promotes more complete dispersion of fuel throughout the combustion chamber prior to initiation of combustion. Specifically, the improved nozzles 10A direct the nominal amount of fuel under pressure in high velocity, outwardly diverging streams (i.e., in higher velocity streams than the streams emanating from nominal nozzles 10) into the combustion chamber, with the fuel stream extending toward, but stopping short of contact with, the surfaces of the respective cylinder and piston before initiation of combustion of the fuel. Further, the nozzle orifices 14A as shown in FIG. 3 are positioned and oriented so that each of the diverging fuel streams closely approaches, but does not overlap (which would affect the desired air/fuel ratio), the diverging fuel streams exiting from adjacent nozzle orifices 14A, so that the streams of fuel substantially fill the combustion chamber with fuel at the desired air/fuel ratio for effective combustion of the fuel.

For purposes of understanding the prior art nozzles for large, medium speed diesel engines, the nominal diesel engine discussed here for illustration has a nominal fuel injection nozzle 10 in each cylinder, as shown in FIGS. 1 and 2, with each nominal nozzle 10 having a projecting nozzle sac 12 with a wall having a generally conical outer surface and a hollow interior. This nominal nozzle sac 12 passes a nominal fuel flow rate through a nominal number of nozzle orifices 14 in the sac wall, at a nominal fuel pressure. Each nominal nozzle orifice 14 has a nominal diameter 18, and a substantially sharp inlet edge 16, as is known in the art. The nominal nozzle 10 has six (6) nominally shaped nozzle orifices 14, with each nominal nozzle orifice 14 having a diameter 18 of approximately 0.38 mm, see FIG. 2. At a nominal fuel pressure, this nominal nozzle 10 can be assumed to pass a nominal fuel flow rate at a given throttle notch setting. The applicants have found that locomotive engines with the typical prior art nozzles tend to emit relatively high levels of emissions and have less than optimal fuel efficiency, and have discovered that the careful selection of nozzle orifice parameters can help solve these engine problems, as described below.

Referring to FIGS. 3 and 4, it has been found that providing an increased number (from 6 to 8) of nozzle orifices 14A in an improved nozzle 10A, while decreasing the diameter 18A of each improved nozzle orifice 14A from 0.38 mm to approximately 0.288 mm and rounding off the improved nozzle orifice inlet edge 16A, can result in an approximate 3% improvement in fuel economy at throttle notch settings 4 and 6, and an approximate 1% improvement in fuel economy at throttle notch setting 8, with injection timing at 4 degrees ATDC. An estimated duty cycle benefit in specific fuel consumption with this nozzle is approximately 2.1%, with a 15% increase in NOx. With injection timing further retarded to 5 degrees ATDC, an estimated duty cycle benefit in specific fuel consumption with this nozzle would be approximately 1.25%, with only a 4.5% increase in NOx.

Thus, while the number of nozzle orifices has been increased by one third, the cross-sectional area of each nozzle orifice has been decreased by approximately one half. Thus, the overall cross-sectional area of the nozzle orifices is decreased approximately 22%. To transfer the nominal quantity of fuel to the combustion chamber via the improved nozzles, the injection pressure is increased. This increased pressure generates the higher velocity streams of fuel, which in turn result in more complete mixing of the air and fuel and more substantial filling of the space available for the air/fuel mixture in the combustion chamber. The coefficient of discharge of the orifices 14A is improved by rounding of the inlet edge 16A of each orifice 14A, as shown in FIG. 3. Rounding of the orifice inlet edge 16A of each orifice 14A in the improved nozzle 10A to create a radius on the edge 16A that is approximately 8% of the orifice diameter 18A has been found to reduce the resistance to flow of the fuel through the nozzle orifice 14A and thus to compensate for the increase in pressure resulting from the reduction in orifice area.

To put the use of this improvement in the fuel injection nozzle 10A into perspective, as discussed above, in the nominal engine, retarding the injection timing for NOx reduction may be accomplished by retarding the start of injection, or by appropriate cam phasing or injector plunger pre-stroke adjustments in a unit injector system. Regardless of how timing is delayed, retarding the timing tends to decrease fuel economy, which can be compensated for by increasing the compression ratio and optimizing the turbo inlet flow area. An additional fuel economy improvement is effected by replacing the nominal fuel injection nozzles 10 found in the nominal engine with improved fuel injection nozzles 10A having a greater number of smaller diameter orifices 14A with rounded inlet edges 16A, thereby achieving more complete pre-combustion dispersion of the fuel and greater fuel economy. This change in injection nozzle performance may be either in addition to or in place of one or more improvements in compression ratio, turbocharger turbine inlet nozzle area, or turbocharger compressor diffuser area.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

1. A fuel injection nozzle for improved fuel efficiency with reduced emissions in a large, medium speed diesel engine of the type generally used on railroad locomotives, with the engine having at least one cylinder, a piston in the cylinder which together with the cylinder defines a combustion chamber, and a fuel injection system for injecting fuel under pressure into the combustion chamber, the improved fuel injection nozzle comprising:
a projection at an end of said improved nozzle toward the combustion chamber comprising a wall member presenting a generally conical outer surface and defining a hollow interior constituting a nozzle sac for receiving fuel under pressure for injection into the combustion chamber;
a plurality of improved nozzle orifices extending through said wall member from said nozzle sac to said outer surface of said wall member, with said improved nozzle orifices being positioned around said projection at generally equally spaced intervals;
wherein each said improved nozzle orifice is sized and shaped to direct the fuel under pressure in a high velocity, outwardly diverging stream into the combustion chamber, with said stream extending toward but stopping short of contact with the surfaces of the respective cylinder and piston before initiation of combustion of the fuel; and
wherein the number of said improved nozzle orifices is selected to position each of said diverging streams closely approaching but not overlapping the diverging streams exiting from adjacent said improved nozzle orifices to substantially fill the combustion chamber with fuel for effective combustion of the fuel.

2. The improved fuel injection nozzle recited in claim 1, wherein:
said nozzle sac is sized to provide a nominal fluid flow rate at a nominal fluid pressure, through a nominal number of nominal nozzle orifices, each said nominal nozzle orifice having a nominal diameter and a substantially sharp inlet edge;
each of said improved nozzle orifices in said improved nozzle is reduced in diameter below the nominal diameter of each of said nominal nozzle orifices;
said plurality of improved nozzle orifices are increased in number above said nominal number of said nominal nozzle orifices; and
each of said improved nozzle orifices has a rounded inlet edge.

3. The improved fuel injection nozzle recited in claim 2, wherein said plurality of improved nozzle orifices are adapted to deliver said nominal fluid flow rate at said nominal fluid pressure.

4. The improved fuel injection nozzle recited in claim 2, wherein the ratio of said reduced diameter of each said improved nozzle orifice to said nominal diameter of each said nominal nozzle orifice is substantially the reciprocal of the ratio of said increased number of said improved nozzle orifices to said nominal number of said nominal nozzle orifices.

5. The improved fuel injection nozzle recited in claim 4, wherein:
said reduced diameter of each said improved nozzle orifice is approximately 75% of said nominal diameter of each said nominal nozzle orifice; and
said increased number of said plurality of improved nozzle orifices is approximately 33% greater than said nominal number of said plurality of nominal nozzle orifices.

6. The improved fuel injection nozzle recited in claim 4, wherein said rounded inlet edge of each said improved nozzle orifice has a radius approximately 0.08 times said diameter of said improved nozzle orifice.

7. In a turbocharged locomotive diesel engine for operation with reduced engine emissions while retaining engine performance, the engine comprising a plurality of cylinders, and a fuel injection system for injecting fuel under pressure into the combustion chamber, the improvement comprising:
cylinders adapted to have an increased engine compression ratio over a nominal compression ratio value;
an improved turbocharger adapted to maintain a nominal air output; and
improved fuel injection nozzles, each said nozzle having a nozzle sac sized to provide a nominal fluid flow rate at a nominal fluid pressure, through a nominal number of nominal nozzle orifices, each said nominal nozzle orifice having a nominal diameter and a substantially sharp inlet edge;
wherein each said improved nozzle has a plurality of improved nozzle orifices, each said improved nozzle orifice being reduced in diameter below the nominal diameter of each of said nominal nozzle orifices;
wherein said plurality of improved nozzle orifices are increased in number above said nominal number of said nominal nozzle orifices; and
wherein each of said improved nozzle orifices has a rounded inlet edge.

8. The improved diesel engine recited in claim 7, wherein said plurality of improved nozzle orifices are adapted to deliver said nominal fluid flow rate at said nominal fluid pressure.

9. The improved diesel engine recited in claim 8, wherein the ratio of said reduced diameter of each said improved nozzle orifice to said nominal diameter of each said nominal nozzle orifice is substantially the reciprocal of the ratio of said increased number of said improved nozzle orifices to said nominal number of said nominal nozzle orifices.

10. The improved diesel engine recited in claim 9, wherein said rounded inlet edge of each said improved nozzle orifice has a radius approximately 0.08 times said diameter of said improved nozzle orifice.

11. A method for reducing emissions from a large, medium speed railroad locomotive diesel engine having an exhaust gas driven turbocharger, while maintaining fuel economy, said method comprising:
providing a fuel injection system for injecting fuel into the cylinders at a nominal rate of fuel consumption;
retarding the injection of fuel in each combustion cycle, to reduce the level of nitrogen oxides in the exhaust gas, with said retarded injection timing also resulting in consumption of fuel at a rate greater than said nominal rate;
increasing compression ratio in each cylinder over a nominal compression ratio value, thereby at least partially compensating for said fuel consumption rate greater than said nominal rate;
increasing turbocharger output of compressed air for combustion in the engine; and
injecting fuel into each cylinder, through a plurality of improved nozzle orifices in an improved fuel injection nozzle, thereby directing the fuel under pressure in a plurality of high velocity, outwardly diverging streams into the combustion chamber, with each said stream extending toward but stopping short of contact with the surfaces of the respective cylinder and piston before initiation of combustion of the fuel, and thereby positioning each of said diverging streams closely approaching but not overlapping the diverging streams exiting from adjacent said improved nozzle orifices to substantially fill the combustion chamber with fuel for effective combustion of the fuel.

12. The method recited in claim 11, further comprising:
selecting a reduced diameter, below a nominal diameter, for each of said improved nozzle orifices in said improved nozzle; and
selecting an increased number, above a nominal number of nozzle orifices, of said improved nozzle orifices in each said improved nozzle.
